(19) United States
(12) Patent Application Publication
(10) Pub. No.: US 2003/0145171 A1
(43) Pub. Date: Jul. 31, 2003

(54) Simplified cache hierarchy by using multiple tags and entries into a large subdivided array

(76) Inventors: Eric S. Fetzer, Longmont, CO (US); Eric DeLano, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 10/062,256

(22) Filed: Jan. 31, 2002

(51) Int. Cl. G06F 13/00

(52) U.S. Cl. 711/122

(57) ABSTRACT

A system and method for reducing the power and the size of a cache memory is implemented by creating a large cache which is subdivided into a smaller cache. One tag controls both the large cache and the smaller, subdivided cache. A second tag controls only the smaller cache. In addition to saving power and area, this system and method may be used to reduce the write-through and write-back effort, improve the latency and the coherency of a cache memory, and improve the ability of multiprocessor system to snoop cache memory.

### CROSS-REFERENCED RELATED APPLICATIONS

This application is related to an application titled “Dynamically Adjusted Cache Power Supply to Optimize for Cache Access or Power Consumption”, H.P. docket number 10016613-1 filed on or about the same day as the present application.

### FIELD OF THE INVENTION

This invention relates generally to electronic circuits. More particularly, this invention relates to improving cache memory performance and reducing cache memory size.

### BACKGROUND OF THE INVENTION

As the size of microprocessors continues to grow, the size of the cache memory included on a microprocessor chip may grow as well. In some applications, cache memory may utilize more than half the physical size of a microprocessor. Methods to reduce the size of cache memory are needed.

On-chip cache memory on a microprocessor may be divided into groups: one group stores data and another group stores addresses. Within each of these groups, cache may be further grouped according to how fast information may be accessed. A first group, usually called L1, may consist of a small amount of memory, for example 16 k bytes. L1 usually has very fast access times. A second group, usually called L2, may consist of a larger amount of memory, for example 256 k bytes, however the access time of L2 may be slower than L1. A third group, usually called L3, may have even a larger amount of memory than L2, for example 4M bytes. The memory contained in L3 may have slower access times than L1 and L2.

A “hit” occurs when the CPU asks for information from a section of the cache and finds it there. A “miss” occurs when the CPU asks for information from a section of the cache and the information isn't there. If a miss occurs in a L1 section of cache, the CPU may look in a L2 section of cache. If a miss occurs in the L2 section, the CPU may look in L3.

Since performance is a major reason for having a memory hierarchy, the speed of hits and misses is important. Hit time is the time to access a level of the memory hierarchy, this includes the time needed to determine whether the access is a hit or a miss. The miss penalty is the time to replace the information from a higher level of cache memory, plus the time to deliver the information to the CPU. Because an lower level of cache memory, for example L1, is usually smaller and usually built with faster memory circuits, the hit time will be much smaller than the time to access information from a higher level of cache memory, for example L2.

Tags are used to determine whether a requested word is in a particular cache memory or not. An individual tag may be assigned to each individual cache memory in the cache hierarchy. FIG. 1 shows a cache hierarchy with three levels of cache memory. Tag L1, 108 is assigned to Cache L1, 102 and they are connected through bus 118. Tag L2, 110 is assigned to Cache L2, 104 and they are connected through bus 120. Tag L3, 112 is assigned to Cache L3, 106 and they are connected through bus 122. Bus 114 connects Cache L1, 102 and Cache L2, 104. Bus 116 connects Cache L2, 104, and Cache L3, 106. A tag should have enough addresses to access all the words contained in a cache. Larger caches require larger tags and smaller caches require smaller tags.

When a miss occurs, the CPU may have to wait a certain number of cycles before it can continue with processing. This is commonly called a “stall.” A CPU may stall until the correct information is retrieved from memory. A cache hierarchy helps to reduce the overall time to acquire information for processing. Part of the time consumed during a miss, is the time used in accessing information from a higher level of cache memory. If the time required to access information from a higher level could be reduced, the overall performance of a CPU could be improved.

The invention described improves the overall CPU performance as well as reduces the physical size and power consumed by the cache memory.

### SUMMARY OF THE INVENTION

An embodiment of the invention provides a system and a method for simplifying a cache memory by using multiple tags and a large cache subdivided to form a smaller second cache. One tag controls both the large cache and the second cache. Another tag controls only the smaller second cache. By using this approach, the performance of a CPU may be improved. The physical size of the cache memory and the power consumed by the cache memory may be reduced. In addition, the write-through time, the write-back time, the latency, and the coherency of the cache memory system may also be improved along with improving the ability of multiple-processor systems to snoop cache memory.

Other aspects and advantages of the present invention will become apparent from the following detailed description, taken in conjunction with the accompanying drawing, illustrating by way of example the principles of the invention.

### BRIEF DESCRIPTION OF THE DRAWINGS

FIG. 1 is a schematic drawing of a cache memory hierarchy containing three cache memory elements controlled by three TAGs.

FIG. 2 is a schematic drawing of a cache memory hierarchy where one cache memory array is a subset of another cache memory array.

FIG. 3 is a schematic drawing of a cache memory hierarchy where the size of a cache memory array contained in another cache memory is variable.

FIG. 4 is a schematic drawing illustrating the principle of write-back in a standard cache memory hierarchy.

FIG. 5 is a schematic drawing illustrating the principle of write-back in a simplified cache memory hierarchy

FIG. 6 is a schematic drawing illustrating the principle of write-through in a standard cache memory hierarchy.

FIG. 7 is a schematic drawing illustrating the principle of write-through in a simplified cache memory hierarchy

FIG. 8 is a schematic drawing illustrating the principle of coherency in a standard cache memory hierarchy.

FIG. 9 is a schematic drawing illustrating the principle of coherency in a simplified cache memory hierarchy.

FIG. 10 is a schematic drawing illustrating how a cache frame may be moved within another cache.

### DETAILED DESCRIPTION OF THE PREFERRED EMBODIMENT

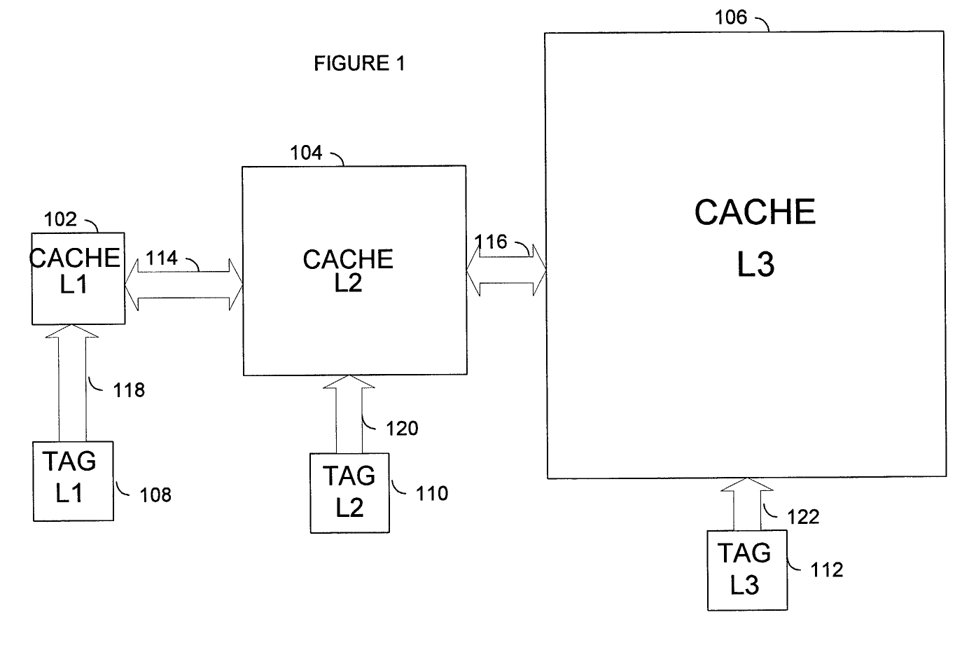

FIG. 1 shows a cache hierarchy with three levels of cache memory. Tag L1, 108 is assigned to Cache L1, 102 and they are connected through bus 118. Tag L2, 110 is assigned to Cache L2, 104 and they are connected through bus 120. Tag L3, 112 is assigned to Cache L3, 106 and they are connected through bus 122. Bus 114 connects Cache L1, 102 and Cache L2, 104. Bus 116 connects Cache L2, 104, and Cache L3, 106. A tag should have enough addresses to access all the words contained in a cache. Larger caches require larger tags and smaller caches require smaller tags.

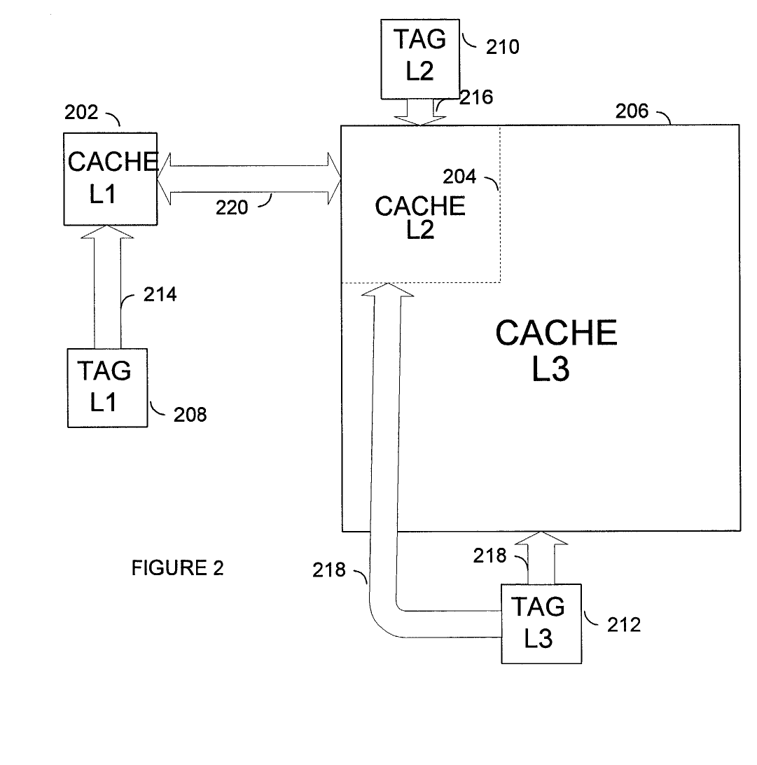

Each cache in FIG. 1 one is physically distinct from the other. Each cache has a tag associated with it. FIG. 2 illustrates how physical memory may be shared between two caches. In FIG. 2, cache L1, 202, is physically distinct from caches L2 and L3. Cache L1, 202, is controlled by tag L1, 208, through bus 214. Cache L2, 204 consists of a physical section of cache L3, 206. Tag L2, 210, controls only cache L2, 204 while tag L3, 212, controls cache L3, 206. Since cache L2, 204 is part of cache L3, 206, tag L3, 212 also controls cache L2, 204. Bus 220 connects cache L1, 202, to cache L2, 204, and to part of cache L3, 206. Tag L2, 210, controls cache L2, 204, through bus 216. Tag L3, 212, controls cache L3, 206 through bus 218.

Because cache L2, 204 is a subset of cache L3, 206, a bus between them is not necessary. The information contained in cache L2, 204, is also part of cache L3, 206. Removing the need for a bus between L2, 204, and L3, 206, reduces the size and complexity of the cache hierarchy. It also helps reduce the power consumed in the cache hierarchy. Size and power are also reduced when cache L2, 204, physically shares part of the memory of cache L3, 206. In a standard cache hierarchy, as shown in FIG. 1, cache L2, 104, is physically distinct from cache L3, 106. As a result, a standard hierarchy, as shown in FIG. 1, may use more area and more power than the hierarchy shown in FIG. 2.

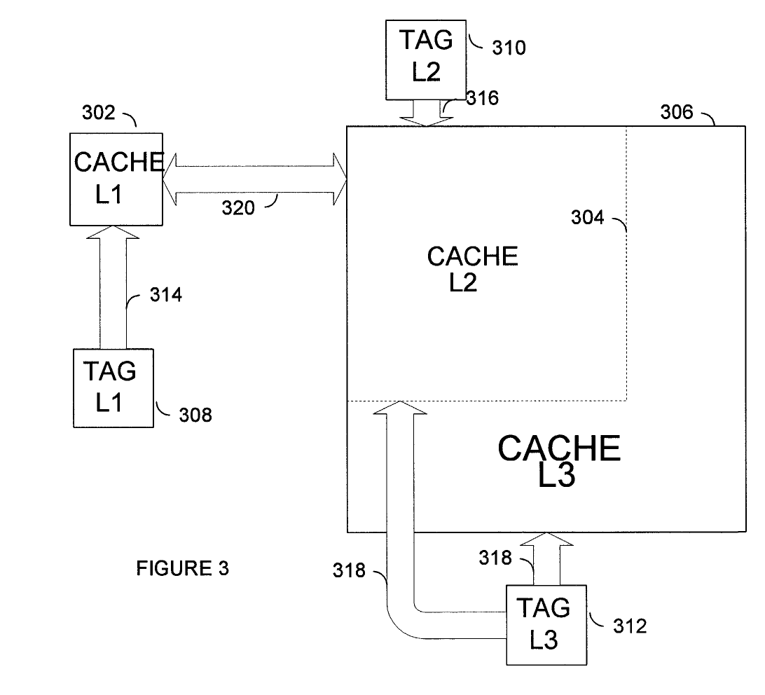

The size of cache L2, 304, may be varied depending on the application. If an application needs a relatively large amount of L2 cache, 304, a larger section of L3, 306, is used. If an application needs a relatively small amount of L2 cache, 304, a smaller section of L3, 306, is used. By adjusting the size of cache L2, 304, according to an application's needs, the overall performance of the CPU may be improved. FIG. 3 illustrates how the size of cache L2, 304, may be increased when compared to cache L2, 204, in FIG. 2. The size of the cache L2, 304, is only limited by the size of the tag controlling it, tag L2, 310.

In addition to reducing the size and power of a cache hierarchy, the cache hierarchy shown in FIG. 2 may also reduce the “write-through” and “write-back” times, improve the “coherency” of the cache, and reduce the latency of the CPU.

There are two basic options when writing to a cache: write-through and write-back. Both write-back and write-though caches have advantages.

With a write-back cache, no extra hardware is needed to write at the speed of the lowest level cache. Another advantage a write-back has is that multiple writes to lower level values often only generate a single write to a higher level cache, thus creating greater bandwidth.

One advantage of a write-through cache is that it is inherently coherent within a cycle or two. Another advantage a write-though cache has is that on a read miss a lower cache does not need to be flushed before new data is read in.

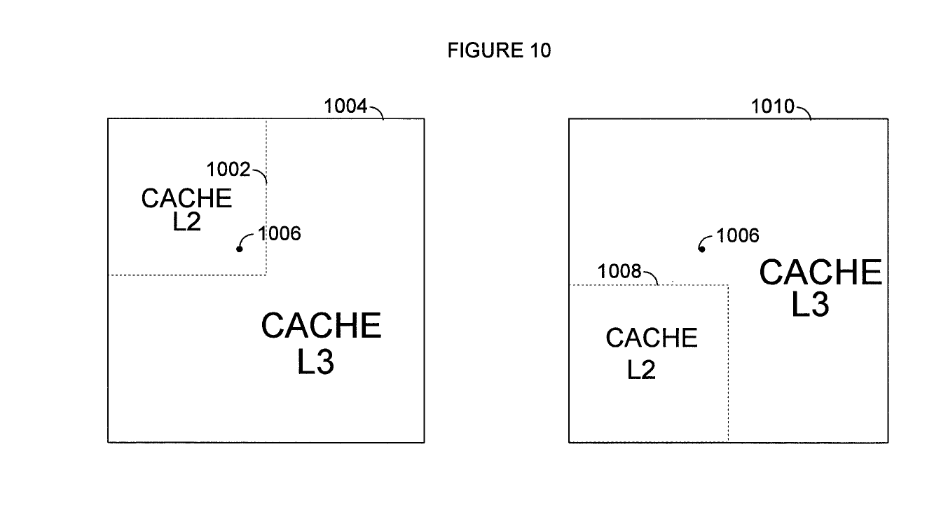

The frame-based, simplified, cache described herein, is inherently write-through because both levels of cache are written to the same cell. Extra hardware is not needed as it is in a standard write-through cache hierarchy. Because the frame defining the smaller cache in the frame-based, simplified cache can be moved, a flush isn't necessary. FIG. 10 illustrates how a lower level cache defined by a frame can be redefined to avoid flushing data. A flush occurs when data in a lower level is updated and the previous data is moved to a higher level of cache. If data in cache L2, 1002, is flushed, data 1006 must be written to a location in cache L3, 1004 and new data from L3, 1004 must be written back to L2, 1002. This may require several cycles to accomplish. If, however, the frame defining cache L2, 1002, is redefined as cache L2 1008, a flush isn't necessary. By moving the frame that defines the L2 cache, the old data is automatically moved to L3, 1010 and the new data is automatically contained in the newly defined L2, 1008.

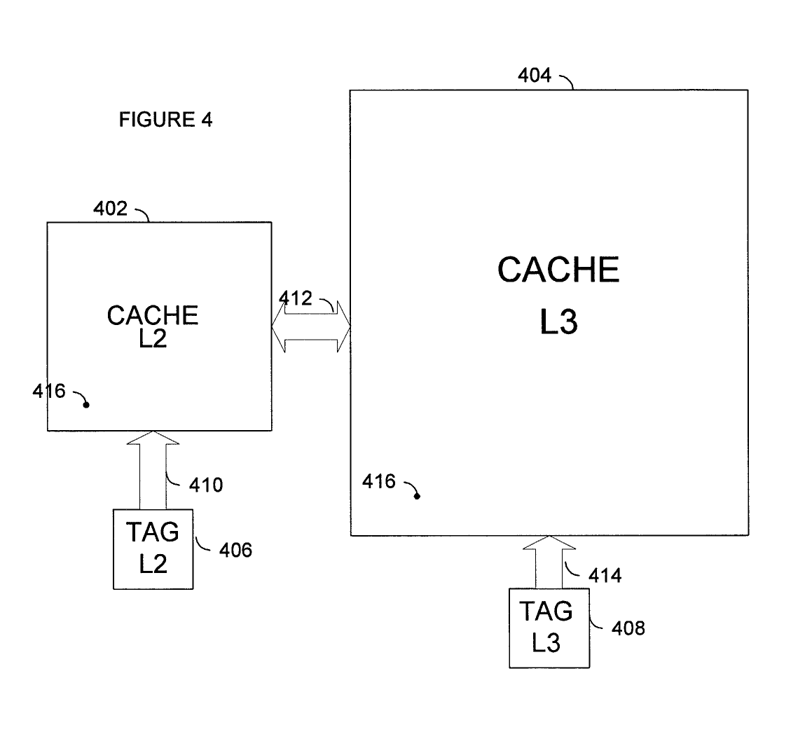

Write-back, also called “copy back” or “store in”, occurs when information is written only to a block in a cache. The modified cache block is written to higher level cache memory only when it is replaced. FIG. 4 is an illustration of two levels of cache memory used in a write-back configuration. In FIG. 4, cache L2, 402, is controlled by tag L2, 406 through bus 410. Cache L3, 404, is controlled by tag L3, 408 through bus 414. Information, 416 may be written from cache L2, 402 to cache L3, 404 through bus 412. A write-back cache can “hide” writes by deferring the write until a port is not busy. A write-though cache does not have this advantage.

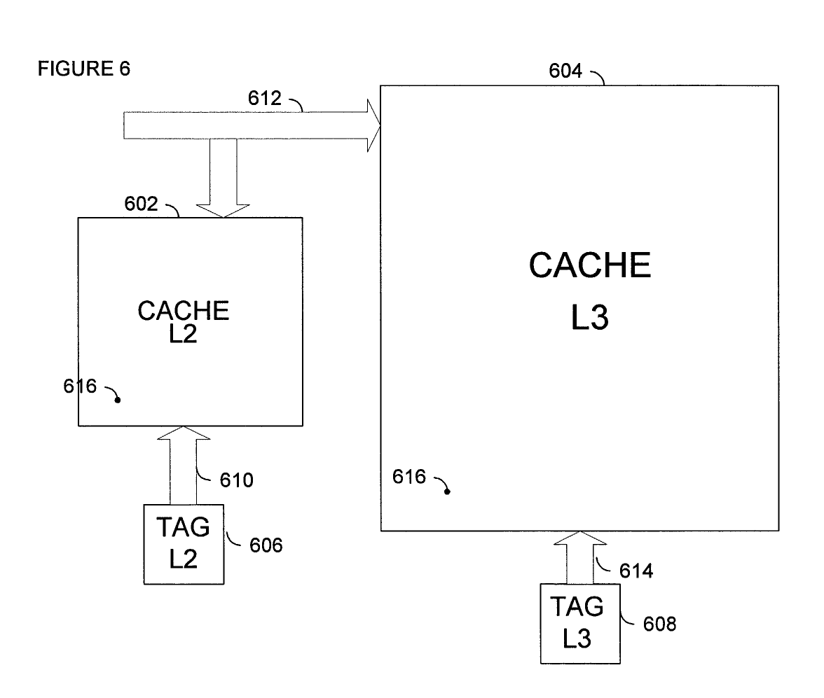

Write-through occurs when information is written to the current cache memory level and a higher cache memory level. FIG. 6 is an illustration of two levels of cache memory where information is written to both levels of cache. In FIG. 6, cache L2, 602, is controlled by tag L2, 606 through bus 610. Cache L3, 604, is controlled by tag L3, 608 through bus 614. Information may be written to both caches L2, 602, and L3, 604, in parallel. In order to write both caches in parallel as opposed to writing one cache at a time, at least one extra state-machine may be needed and more connectivity may be required.

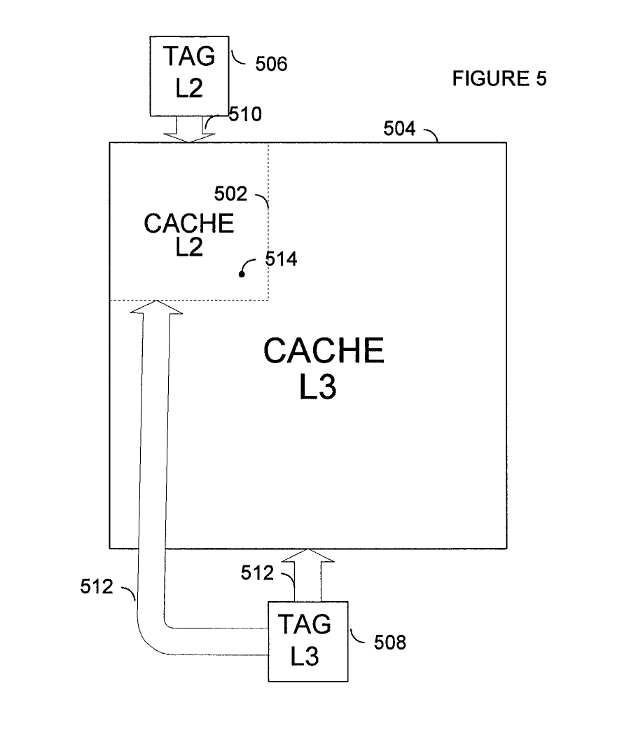

FIG. 5 illustrates how a write-back time may be improved by writing to a physical location only one time. In FIG. 5, cache L2, 502, is controlled by tag L2, 506, through bus 510 and tag L3, 508, through bus 512. Cache L3, 504, is controlled by tag L3, 508 through bus 512, only. Information, 514, stored in cache L2, 502, is also stored in cache L3, 504 because cache L2, 502 is part of cache L3, 504. Because information, 514, stored in cache L2, 502, is simultaneously stored in cache L3, 504, write-through occurs in both cache L2, 502, and cache L3, 504. In addition, this simplified hierarchy, reduces the number of state-machines required and the amount of connectivity needed in a standard write-through cache as shown in FIG. 4. The reduction of the number of state-machines required and the amount of connectivity needed also reduces the overall physical size of the cache and reduces the power consumed by the cache.

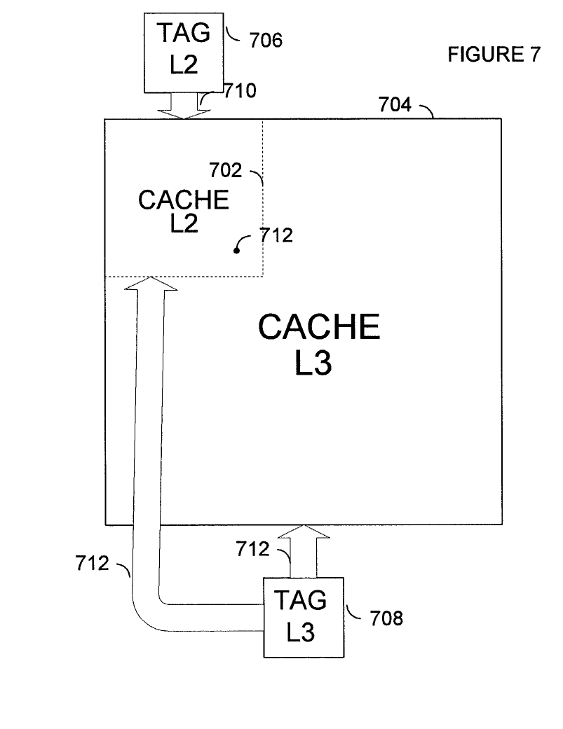

FIG. 7 illustrates how write-through time may be improved by writing to a physical location only one time. In FIG. 7, cache L2, 702, is controlled by tag L2, 706, through bus 710 and tag L3, 708, through bus 712. Cache L3, 704, is controlled by tag L3, 708 through bus 712, only. Information, 714, stored in cache L2, 702, is also stored in cache L3, 704 because cache L2, 702 is part of cache L3, 704. Because information, 714, stored in cache L2, 702, is simultaneously stored in cache L3, 704, write-through occurs in both cache L2, 702, and cache L3, 704 at nearly the same time. Because both caches L2 and L3 are written at nearly the same time, write-through time is reduced when compared to write-through times in a standard cache hierarchy as shown in FIG. 6. In addition, this simplified hierarchy, reduces the number of state-machines required and the amount of connectivity needed in a standard write-through cache as shown in FIG. 6. The reduction of the number of state-machines required and the amount of connectivity needed also reduces the overall physical size of the cache and reduces the power consumed by the cache.

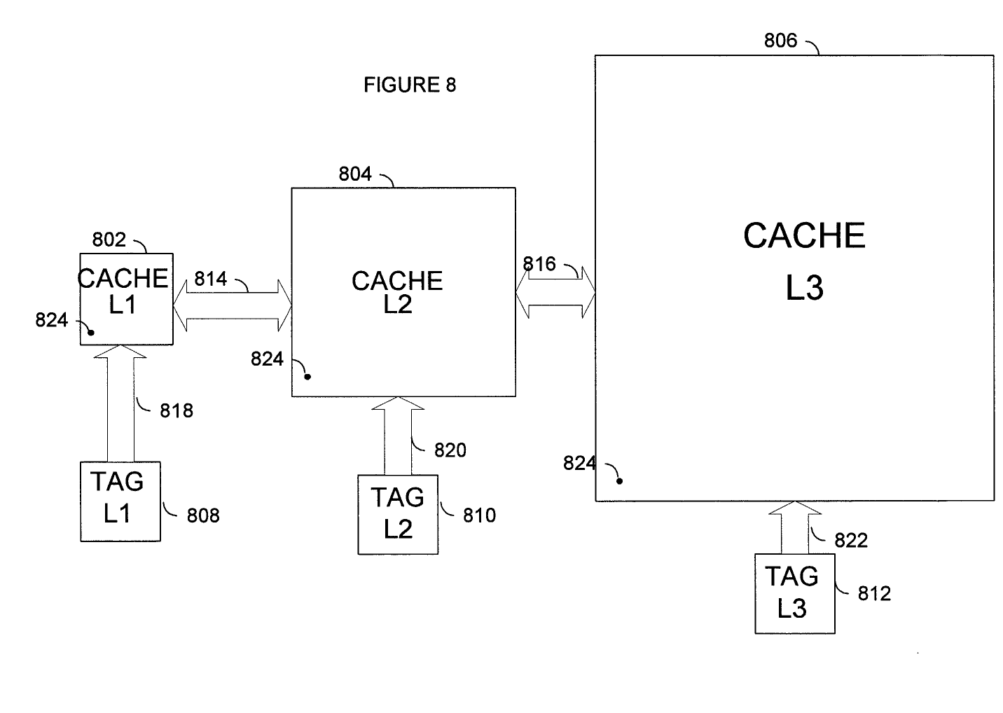

Coherency is an issure when the same information is stored in several levels of a cache memory hierarchy. FIG. 8 illustrates the principle of coherency. In FIG. 8, cache L1, 802, is controlled by tag L1, 808 through bus 818. Cache L2, 804, is controlled by tag L2, 810 through bus 820. Cache L3, 806, is controlled by tag L3, 812, through bus 822. Information may be transferred to and from caches L1, 802, and L2, 804, through bus 814. Information may be transferred to and from caches L2, 804, and L3, 806, through bus 816. In order to maintain coherency, information must be transferred from cache L1, 802, to cache L2, 804 and then from cache L2, 804 to cache L3, 806. Transferring information from one cache level to another requires more circuitry, more power and more physical area. The time required to maintain coherency decreases the memory bandwidth of the CPU. Increased latency slows the CPU performance.

A write-through cache is coherent by design. If a cache is coherent, external resources only have to look at the higher level cache and not the lower level because it is guaranteed the data in the higher level will match the data in the lower level.

A write-back cache is not coherent. External sources must look at both levels of cache, thus reducing bandwidth.

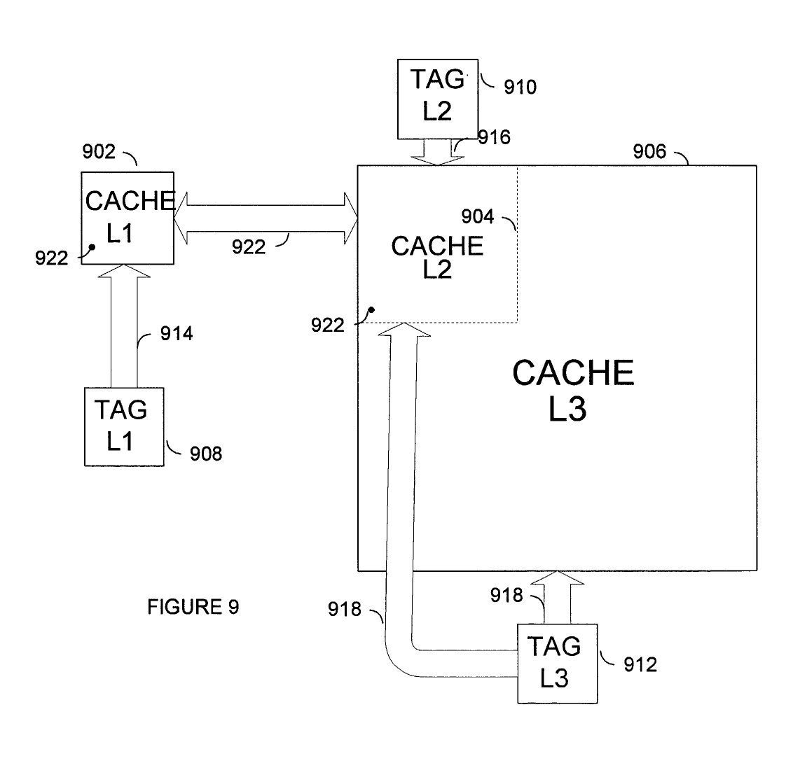

Coherency may be obtained by physically forming a lower cache memory level from part of a larger, higher cache memory level. In FIG. 9, cache L1, 902, is controlled by tag L1, 908 through bus 914. Cache L2, 904, is controlled by tag L2, 910 through bus 916 and by tag L3, 906 through bus 918. Cache L3, 906, is controlled by tag L3, 912, through bus 918. Information, 922 may be transferred to and from caches L1, 902, and L2, 904, through bus 920. Information, 922, stored in cache L2, 904, is also stored in cache L3, 906 because cache L2, 904 is part of cache L3, 906. Because information, 922, stored in cache L2, 904, is simultaneously stored in cache L3, 906, coherency between cache L2, 904, and L3, 906 is always maintained. This also reduces the amount of circuitry needed, lowers the power, and reduces the physical area needed. Because the time to maintain coherency is decreased, the bandwidth of the CPU is increased. Reduced latency improves the CPU performance.

In addition to the improvements described, a simplified cache also improves the ability of a multiprocessor system to “snoop” cache memory. Every cache that has a copy of the data from a block of physical memory also has a copy of the information about it. These caches are usually on a shared-memory bus, and all cache controllers monitor or “snoop” on the bus to determine whether or not they have a copy of the shared block.

Snooping protocols should locate all the caches that share the object to be written. In a standard hierarchy, write-back cache, each level of cache must be checked when snooping. Because the information stored in a framed based, simplified cache is physically located in the same place for two levels of cache memory, the time used for snooping may be reduced. Reducing the snoop time may increase the bandwidth of the CPU.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A cache memory system comprising:
a first cache memory
a second cache memory;
a first tag electrically connected to said first cache memory;
a second tag electrically connected to said first and said second cache memories;
wherein said first cache memory is a subset of said second cache memory;
wherein said first tag controls said first cache memory and said second tag controls said first and said second cache memories.

2) The cache memory system as in claim 1 wherein said cache memories and said tags are configured to reduce the physical size of said cache memory system.

3) The cache memory system as in claim 1 wherein said cache memories and said tags are configured to reduce the power consumed by said cache memory system.

4) The cache memory system as in claim 1 wherein said cache memories and said tags are configured to increase the bandwidth of said cache memory system.

5) The cache memory system as in claim 1 wherein said cache memories and said tags are configured to reduce write-through effort of said cache memory system.

6) The cache memory system as in claim 1 wherein said cache memories and said tags are configured to improve coherency of said cache memory system.

7) A method of reducing the physical size of a cache memory system comprising:
fabricating a first tag and a second tag;
fabricating a first cache memory;
wherein a second cache memory is a subset of said first cache memory;
wherein said second tag controls said second memory and said first tag controls said first and said second cache memories.

8) A method of reducing power in a cache memory system comprising:
fabricating a first tag and a second tag;
fabricating a first cache memory;
wherein a second cache memory is a subset of said first cache memory;
wherein said second tag controls said second memory and said first tag controls said first and said second cache memories.

9) A method of reducing the latency in cache memory system comprising:
fabricating a first tag and a second tag;
fabricating a first cache memory;
wherein a second cache memory is a subset of said first cache memory;
wherein said second tag controls said second memory and said first tag controls said first and said second cache memories.

10) A method of improving a write-through time of a cache memory system comprising:
fabricating a first tag and a second tag;
fabricating a first cache memory;
wherein a second cache memory is a subset of said first cache memory;
wherein said second tag controls said second memory and said first tag controls said first and said second cache memories.

11) A method of improving coherency of a cache memory system comprising:
fabricating a first tag and a second tag;
fabricating a first cache memory;
wherein a second cache memory is a subset of said first cache memory;
wherein said second tag controls said second memory and said first tag controls said first and said second cache memories.

12) A method of improving a write-through time of a cache memory system comprising:
fabricating a first tag and a second tag;
fabricating a first cache memory;
wherein a second cache memory is a subset of said first cache memory;
wherein said second tag controls said second memory and said first tag controls said first and said second cache memories;
wherein a flush is implemented by moving said second cache memory to a different location within said first cache memory.
